(19) United States
(12) Patent Application Publication
(10) Pub. No.: US 2013/0235490 A1
(43) Pub. Date: Sep. 12, 2013

(54) Perpendicular magnetic recording media with seed layer structure containing ruthenium (Ru)

(71) Applicants: Hoa Van Do, Fremont, CA (US); Kentaro Takano, San Jose, CA (US); Qi-Fan Xiao, San Jose, CA (US); Chu Sy Tran, San Jose, CA (US)

(72) Inventors: Hoa Van Do, Fremont, CA (US); Kentaro Takano, San Jose, CA (US); Qi-Fan Xiao, San Jose, CA (US); Chu Sy Tran, San Jose, CA (US)

(73) Assignee: Hitachi Global Storage Technologies Netherlands B.V.

(21) Appl. No.: 13/385,860

(22) Filed: Mar. 9, 2012

(51) Int. Cl. G11B 5/012; G11B 5/66; G11B 5/84

(52) U.S. Cl. 360/110; 427/131; 428/831; G9B/5.024; G9B/5.241; G9B/5.295

(57) ABSTRACT

An embodiment of the invention provides an apparatus that includes: a perpendicular magnetic recording medium including a substrate, a soft under layer above the substrate, a seed layer structure above the soft under layer, wherein the seed layer structure contains Ruthenium; and a magnetic recording layer above the seed layer structure.

### TECHNICAL FIELD

Embodiments of the invention relate generally to perpendicular magnetic recording media.

### BACKGROUND

Information can be recorded on a storage media by use of magnetic recording. Magnetic recording media are widely used in various devices such as hard disk drives and used in various industries such as the computer industry and the data storage industry. Efforts are continually being made to increase areal recording density (i.e., bit density of the magnetic media) of the media. In order to increase the recording densities, perpendicular recording media structures (PMR) have been developed and have been found to be superior to longitudinal recording media.

In perpendicular magnetic recording media, the recording bits are stored in a perpendicular or out-of-plane orientation in a recording layer of the recording media. The perpendicular orientation allows the recording bits to be more tightly packed in the horizontal direction.

Magnetic flux transmitted from a write head will affect the bits directly below the write head when the magnetic flux transmits down through the vertical bit area, through the soft underlayer, and back up the return pole. Examples of disk drive systems and magnetic heads for use with perpendicular magnetic recording media are disclosed in, for example, U.S. patent application Ser. No. 12/231,513, entitled PERPENDICULAR MAGNETIC RECORDING MEDIUM AND MAGNETIC RECORDING AND REPRODUCING APPARATUS USING THE SAME, U.S. patent application Ser. No. 11/645,252, entitled PERPENDICULAR MAGNETIC RECORD MEDIUM AND MAGNETIC STORAGE SYSTEM, and U.S. patent application Ser. No. 12/577,344, entitled PATTERNED PERPENDICULAR MAGNETIC RECORDING MEDIUM WITH DATA ISLANDS HAVING A FLUX CHANNELING LAYER BELOW THE RECORDING LAYER. Application Ser. Nos. 12/231,513, 11/645,252, and 12/577,344 are assigned to and owned by Hitachi Global Storage Technologies Netherlands B.V.

Cobalt based alloys are widely used in the recording layer of perpendicular magnetic recording media. By improving the crystalline C-axis (magnetic anisotropy is aligned along this crystalline axis) orientation in the vertical or perpendicular direction to the recording layer plane, the effective perpendicular magnetic anisotropy is increased, which leads to an increase in the coercivity of the recording layer. The improved orientation and higher coercivity can result in an improvement in the signal-to-noise ratio (SNR) and narrowing of the magnetic track width, which can yield an improvement in the areal density performance of the perpendicular recording media.

In conventional perpendicular magnetic recording media technology, a seed layer is increased in thickness in the recording media in order to achieve improved crystalline orientation in the magnetic layer so that the coercivity is increased. However, a thicker seed layer also forms larger-sized grains in the recording layer, and these larger-sized grains contribute to increased noise in the recording layer because the SNR is reduced due to the reduction in the number of grains per bit (due to the larger grain volume).

Therefore, there is a continuing need to achieve enhanced crystalline orientation in perpendicular magnetic recording media so that increased recording density and improved SNR are achieved.

### SUMMARY

In one embodiment of the invention, an apparatus includes: a perpendicular magnetic recording medium including a soft under layer, a seed layer structure above the soft under layer, wherein the seed layer structure contains Ruthenium, and a magnetic recording layer above the seed layer structure.

In another embodiment of the invention, an apparatus includes: a perpendicular magnetic recording medium including a substrate, a soft under layer above the substrate, a seed layer structure above the soft under layer, wherein the seed layer structure comprises a first seed layer and a second seed layer above the first seed layer and wherein the second seed layer contains Ruthenium, and a magnetic recording layer above the seed layer structure.

In yet another embodiment of the invention, an apparatus includes a magnetic disk drive. The magnetic disk drive includes: a magnetic head for writing magnetic transitions in a perpendicular magnetic recording medium on a disk. The disk with the perpendicular magnetic recording medium includes: a substrate, a soft under layer above the substrate, a seed layer structure above the soft under layer, wherein the seed layer structure contains Ruthenium, and a magnetic recording layer above the seed layer structure.

In yet another embodiment of the invention, an apparatus includes: a perpendicular magnetic recording medium including a substrate, a soft under layer above the substrate, a magnetic recording layer, and means for controlling an orientation of grains in the magnetic recording layer, wherein the controlling means is above the soft under layer and wherein the controlling means contains Ruthenium.

In yet another embodiment of the invention, a method includes: providing a substrate, forming a soft under layer above the substrate, forming a seed layer structure above the soft under layer, wherein the seed layer structure contains Ruthenium, and forming a magnetic recording layer above the seed layer structure, wherein the recording layer is part of a perpendicular magnetic recording medium.

It is to be understood that both the foregoing general description and the following detailed description are exemplary and explanatory only and are not restrictive of the invention, as claimed.

The accompanying drawings, which are incorporated in and constitute a part of this specification, illustrate one (several) embodiment(s) of the invention and together with the description, serve to explain the principles of the invention.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of the layers in a perpendicular magnetic recording media, in accordance with an embodiment of the invention.

FIG. 2 is a block diagram of the layers in a perpendicular magnetic recording media, in accordance with another embodiment of the invention.

FIG. 3 is a block diagram of a plan view image of the structure of a magnetic recording layer in a perpendicular magnetic recording medium, in accordance with an embodiment of the invention.

FIG. 4 is a graph showing magnetic field values for different thickness values of a seed layer structure, in accordance with various embodiments of the invention.

FIG. 5 is a chart showing rocking curve angle values for seed layer structures in accordance with various embodiments of the invention.

FIG. 6 is a chart showing recording performance for seed layer structures in accordance with various embodiments of the invention.

FIG. 7 is a block diagram of a magnetic disk drive that can operate with a magnetic recording media in accordance with an embodiment of the invention.

### DETAILED DESCRIPTION OF PREFERRED EMBODIMENTS

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, layers, and/or the like. In other instances, well-known structures, materials, layers, or operations are not shown or described in detail to avoid obscuring aspects of embodiments of the invention. Additionally, the figures are representative in nature and their shapes are not intended to illustrate the precise shape or precise size of any element and are not intended to limit the scope of the invention.

For purposes of the discussion herein, the following terms are also defined as follows: the terms “above” or “on” means above, but not necessarily in contact with, and the term “alloy” means a composition of matter with two or more elements, wherein at least one of the elements is a metal. An alloy of a composition of matter can include itself (e.g., an FeCo alloy includes FeCo).

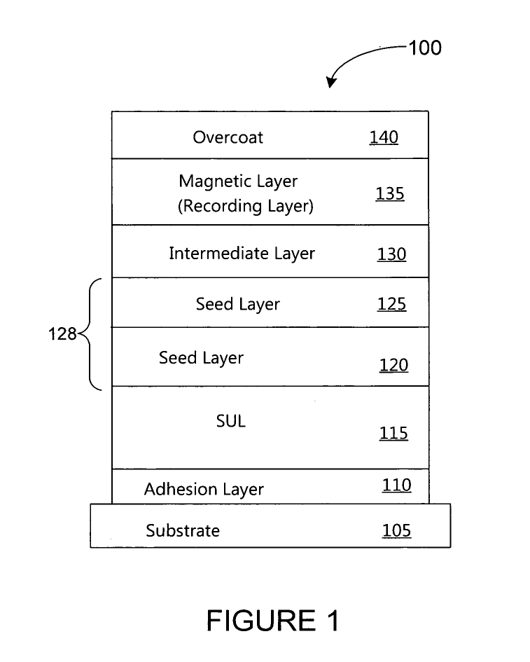

FIG. 1 is a block diagram of the layers in a perpendicular magnetic recording media 100, in accordance with an embodiment of the invention. The term “media 100” is defined herein as a single recording medium 100 or as a plurality of recording medium 100. The media 100 can be used, for example, as a disk in a disk drive or as another-type of device in a computing system, data storage system, or other systems.

The media 100 includes a substrate 105 that can be used for magnetic media. Above the substrate is an adhesion layer 110. Above the adhesion layer 110 is a soft under layer (SUL) 115. Above the SUL 115 is a first seed layer 120. Above the first seed layer 120 is a second seed layer 125. The first seed layer 120 and the second seed layer 125 together form dual seed layer structure 128 (i.e., seed layer structure 128) in accordance with an embodiment of the invention. Above the second seed layer 125 is an intermediate layer 130. Above the intermediate layer 130 is a magnetic recording layer 135 (i.e., magnetic layer 135 or recording layer 135). Above the magnetic recording layer 135 is an overcoat 140. The layers above the substrate 105 may be sputter deposited onto the media 110, and will be discussed further below, or can be formed on the substrate 105 by another suitable method. As an example, Ar (Argon) gas can be used as part of the sputter deposition process. The perpendicular magnetic recording media 100 is manufactured by using a sputtering apparatus such as, for example, the LEAN 200 (C-3040) sputtering apparatus that is manufactured by INTEVAC (Canon Anelva) Company or other suitable sputtering devices known to those skilled in the art.

The substrate 105 is any substrate that can be used for magnetic media. The substrate 105 can be, for example, glass, AlMg, ceramics, glass/ceramic mixtures, or other suitable materials. Other materials that can be used for the substrate 105 include, for example, a conventional aluminum alloy with a NiP surface coating, or an alternative disk blank, such as silicon, canasite or silicon-carbide. The substrate 105 is, for example, approximately 0.6 or 0.8 mm in thickness.

The convention for alloy composition used in the discussion herein gives the atomic percentage (at. %) of an identified element with the balance being with the other element in the composition. The example atomic percentage compositions described herein are given without regard for the potential small amounts of contaminants that invariably exist in sputtered thin films as is well known to those skilled in the art. For instance NiTa20W5 is an alloy of 75 at. % Ni, 20 at. % Ta and 5 at. % W. Similarly, NiTa (20 at. %) W (5 at. %) is an alloy of 75 at. % Ni, 20 at. % Ta and 5 at. % W.

In forming the film layers for the media 100, the metal, oxides and carbon materials can be formed by DC sputtering or RF sputtering. The oxides can be deposited from either a metallic or oxide containing target and be sputtered in a reactive gas environment.

The adhesion layer 110 prevents any exfoliation between the substrate 105 and the films stacked thereon. The adhesion layer 110 is made of, for example, NiTa (AITi) or a similar material. The adhesion layer 110 is, for example, between approximately 2 nm and 50 nm (20 nm) in thickness. The adhesion layer 110 is formed on the substrate 105 with, for example, sputtering. The target has a composition of, for example, AlTi (40-60 at. %).

The SUL 115 is for providing a flux return path for the magnetic field from the read/write pole head. The SUL layer 115 is typically a relatively low-coercivity magnetically permeable underlayer. The SUL layer 115 is made of, for example, an alloy of CoTaZr or other suitable materials. Other materials that can be used for the SUL layer 115 are, for example, the alloys of CoNiFe, FeCoB, CoCuFe, NiFe, FeAlSi, FeTaN, FeN, FeTaC, FeC, CoFeTaZr, CoFeB, CoB, CoTaNb, and CoZrNb, or a laminated structure formed of multiple soft magnetic films separated by nonmagnetic films, such as electrically conductive films like Al and CoCr or antiferromagnetic coupling films. As other examples, the SUL layer 115 is a stacked or laminated film composed of a Ru film and a soft magnetic film made of various particular compounds discussed above. The SUL layer 115 is, for example, between approximately 10 nm and 200 nm in thickness. The SUL layer 115 is formed with, for example, sputtering. The target has a composition of, for example, CoTa (8-12 at. %) Zr (1-4 at. %).

The dual seed layer structure 128 is provided to improve and control the crystalline orientation of the recording layer 135, by controlling the growth orientation of crystals (grains) in the magnetic recording layer 135. The use of the dual seed layer structure 128 leads to an improved magnetic media crystal orientation, as observed or measured as a narrower rocking curve width (XRD rocking curve angle) of the magnetic grains in the magnetic recording layer 135. This narrower rocking curve width shows that the material has a tighter/narrower distribution of crystal orientation which leads to a higher coercivity (Hc) than a material with a higher rocking curve width and a less well defined crystal orientation. This increased coercivity increases the threshold (makes it harder) for the magnetic write head to reverse the polarity of a magnetic grain during write operations, and therefore, this increased coercivity limits the reversal of the media to a narrower higher field region underneath the write pole of the magnetic write head during write operations. The increased coercivity can achieve a higher recording density because a narrower written track may be achievable that can improve areal density. This method can also achieve higher coercivities without resorting to increasing the grain size in the recording layer 135. Further, the more narrow distribution of the media reduces the noise of the media because a narrower distribution yields more grains more closely oriented in the proper vertical direction.

Additionally, an embodiment of the invention uses a seed layer with Ru which permits the seed layer to be decreased in thickness. In conventional perpendicular magnetic recording media technology, the seed layer is increased in thickness in order to achieve improved crystalline orientation (and the resulting higher coercivity) in the magnetic recording layer. However, a thicker seed layer also forms larger-sized magnetic grains that contribute to increased noise in the recording layer. In other words, an embodiment of the invention allows the use of a thinner seed layer to achieve the same (or an enhanced) coercivity (Hc) as compared to a media with a thicker seed layer, since the thinner seed layer avoids increasing magnetic grain size and larger magnetic grain sizes lowers the SNR. Therefore, an embodiment of the invention provides a decreased seed layer thickness to create smaller grains that provides a pathway to increased SNR. The properties in the seed structure 128 (which contains Ru) results in the narrower rocking curve width in the magnetic grains.

The first seed layer 120 is made of, for example, an alloy of NiFe. The first seed layer 120 is, for example, approximately 0.5 nm-5 nm and preferably 1.5 nm-2.5 nm in thickness. The second seed layer 125 is made of, for example, an alloy of NiWRu. The second seed layer 125 is, for example, approximately 0.5 nm-6 nm and preferably 2 nm-5 nm in thickness. The effect of adjusting the thickness of the first and second seed layers will be discussed below. Also discussed below is another embodiment of the invention, where the perpendicular magnetic recording media will have only a single seed layer and that single seed layer being Ru including seed layer 125.

The seed layers 120 and 125 are each formed with, for example, sputtering. As an example, Ar gas can be used for performing the sputter deposit process for the seed layers 120 and 125. For the first seed layer 120, the layer has a composition of, for example NiFe (5-55 at. %) and preferably NiFe (15-40 at. %). For the second seed layer 125, the layer has a composition of, for example, NiW (2-10 at. %) Ru (3-9 at. %) and preferably NiW (6-8 at. %) Ru (4-6 at. %). In some embodiments seed layers 120 or 125 is directly on SUL 115. In some embodiments intermediate later 130 is directly on seed layer 125.

The intermediate layer 130 also helps to improve the crystallographic texture of the magnetic recording layer and the attainment of improved magnetic properties. The intermediate layer 130 helps promote segregation of non-magnetic material (e.g., Si oxide or any other oxide or nitrides) into grain boundaries in magnetic recording layer 135. The intermediate layer 130 is made of, for example, Ru or a similar material. The intermediate layer 130 is, for example, between approximately 2 nm and 30 nm in thickness. The intermediate layer 130 is formed with, for example, sputtering.

The recording layer 135 is the layer in which information is recorded as magnetization information. Since the media 100 is a perpendicular magnetic recording media, the direction of magnetization of the recording layer 135 is in the direction perpendicular to the film surface. The recording layer 135 is made of material composed of ferromagnetic crystal grains. For example, the recording layer 135 is made of the Co—Cr—Pt alloy film, with the grains being separated by a non-magnetic material. As another example, the recording layer 135 is another type of cobalt alloy such as CoCr or CoCr with one or more of Pt, Nb and Ta. As another example, the recording layer 135 is a multilayer film with Co and Pd or Pt being alternately layered and with the grains being separated by a non-magnetic material. The non-magnetic material can be, for example, any of the Ta, W, Nb, V, Mo, B, Si, Co, Cr, Ti, Al, and Zr oxides or nitrides.

As a particular example, the recording layer 135 is made of a cobalt alloy magnetic film containing Co (60-70 at. %) Pt (15-25 at. %) Cr (5-15 at. %)—SiO₂. The recording layer 135 is, for example, between approximately 8 nm and 25 nm in thickness. The recording layer 135 is formed with, for example, sputtering.

The overcoat 140 is provided for protecting the layers which are successively disposed on the substrate 105. The overcoat 140 is made of, for example, a carbon film. This carbon film can be an amorphous diamond-like carbon film. The overcoat 140 can also be made of other known protective overcoats, such as, for example, Si-nitride, BN or B4C. The overcoat 140 is, for example, between approximately 1 nm and 5 nm in thickness. The overcoat 140 is formed with, for example, sputtering. Of course, the thinner the overcoat 140 in thickness, the closer the slider will fly over the media. Generally, less distance between the slider and media improves the recording and reading characteristics of a recording system.

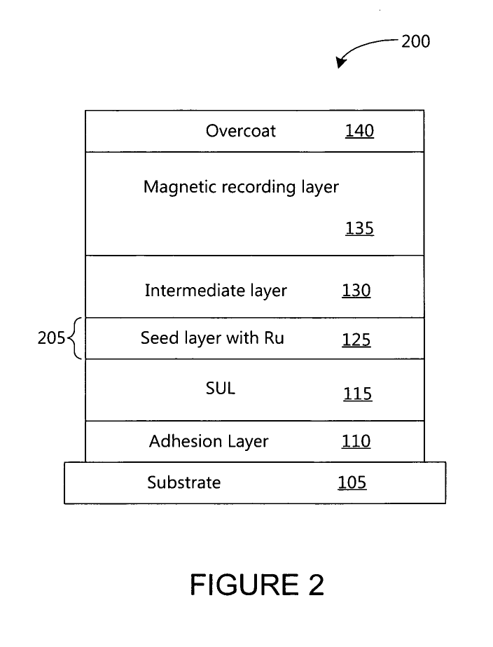

FIG. 2 is a block diagram of the layers in a perpendicular magnetic recording media 200, in accordance with another embodiment of the invention. As mentioned above, in this embodiment, the seed layer structure 205 includes a single seed layer 125 containing Ru and does not include the seed layer 120 (FIG. 1). As discussed above, the seed layer 125 is made of, for example, NiWRu. The recording performance and characteristics of the media 200 with the single seed layer structure 205 (with Ru) and the media 100 with the dual-seed layers structure 128 (FIG. 1) will be discussed below.

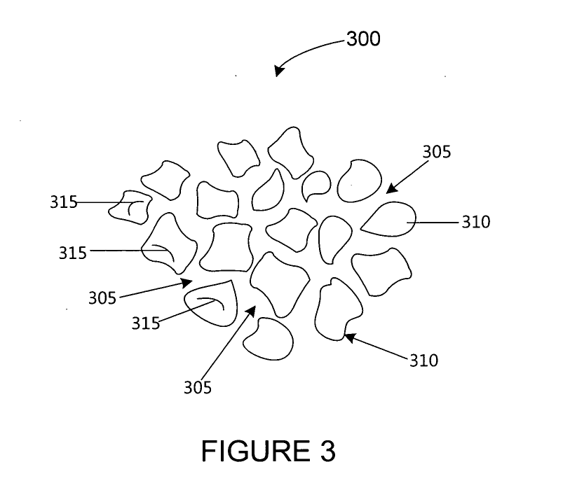

FIG. 3 is a block diagram of a plan view image 300 of the structure of a magnetic recording layer in a perpendicular magnetic recording media, in accordance with an embodiment of the invention. This image 300 can be observed by using, for example, a high-resolution transmission electron microscope. The crystal grain boundaries 305 (which are non-magnetic regions) are identified around the crystal grains 310. In practice, oxide segregant material 315 that could migrate to the grain boundaries may get trapped within the grain structure.

The intermediate layer 130 (e.g., Ru layer) (FIG. 1) could have increased irregularities (or/and roughness or/and variance or/and texturing) due to the Ru surface roughness in the seed layer structures (FIGS. 1 and 2). The increased irregularities in the intermediate layer 130 promote the magnetic de-coupling of the crystal grains 310 in the magnetic recording layer 135 by contributing to the separation of grains 310 along the non-magnetic boundaries 305. Due to the sufficient grain boundaries 305 leading to more de-coupled grains in the magnetic recording layer 135, the signal-to-noise ratio is increased in a perpendicular magnetic recording media with the seed layer structures (structure 128 in FIG. 1 or structure 205 in FIG. 2).

In an optimal perpendicular recording media, the direction of magnetization of the crystal grains in the magnetic layer are aligned perpendicular to the film plane. The C-axis (vertically oriented crystal axis) of the cobalt alloy in the magnetic layer 135 is desired to be perpendicular to the plane of the magnetic layer 135 so that the layer 135 has strong perpendicular magnetic anisotropy. In an embodiment of the invention, the seed layer structure 128 in FIG. 1 (or structure 205 in FIG. 2) improves the perpendicular crystalline C-axis orientation and also achieves a higher coercivity and a reduced rocking curve angle. A higher coercivity can allow a narrower written track to be achieved in the recording layer which can help increase recording density without degrading the SNR. Therefore, it is advantageous to reduce the rocking curve angle in perpendicular magnetic recording media.

In conventional perpendicular magnetic recording media technology, a seed layer is increased in thickness in the recording media in order to achieved improved crystalline orientation in the magnetic layer so that the coercivity is increased. However, a thicker seed layer also forms larger-sized grains in the recording layer, and these larger-sized grains contribute to increased noise in the recording layer. On the other hand, to obtain a high SNR of the cobalt alloy perpendicular media, the grain size of the media is made sufficiently small to obtain the high resolution required for sharp magnetic bit transitions. Embodiments of the invention can advantageously avoid the use of thicker seed layers and can therefore overcome the above problems in conventional technology. In embodiments of the invention, the seed layer structures 128 and 205 (FIGS. 1 and 2, respectively) are relatively small in thickness and allows the formation of smaller grain sizes in the recording layer 135, while achieving a high coercivity due to a good C-axis orientation as discussed above. The enhanced SNR performance and high coercivity is a result of the improved orientation in the recording layer 135, due to the balance of properties between the seed layer 125 (which contains Ru) and the intermediate layer 130 (which contains Ru).

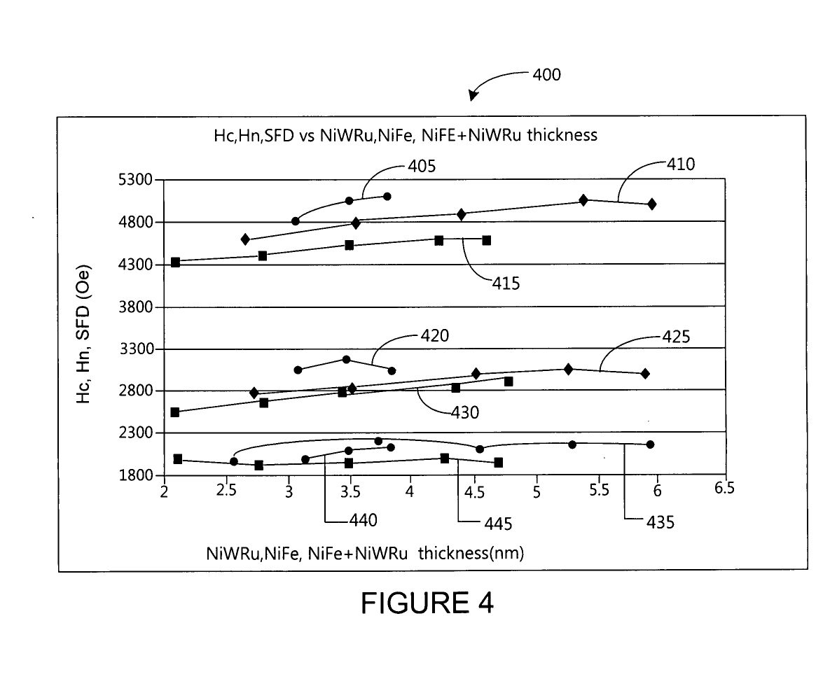

FIG. 4 is a graph 400 showing magnetic field values for different thickness values of a seed layer structure, in accordance with various embodiments of the invention. The coercivity field (Hc) (Oersted) in the perpendicular magnetic recording media with the dual seed layers structure 128 (FIG. 1), which contains NiFe+NiWRu, increases as the seed layers structure 128 thickness is increased, as shown by line 405. The Hc field in the media with the dual seed layer structure 128 is greater than the Hc field (line 410) for media with the single seed layer structure 205 (FIG. 2), which contains the single seed layer 120 of NiWRu. The Hc field for media with the single seed layer structure 205 is greater than the Hc field (line 415) for media with a single NiFe seed layer. Therefore, the graph 400 illustrates the increased coercivity for media with the seed layer structures 128 (FIG. 1) or 205 (FIG. 2) in accordance with various embodiments of the invention.

Also shown in the graph 400 are the following lines that further show additional magnetic characteristics of media with the various seed layers mentioned above. The lines 420, 425, and 430 represent the switching field distribution for media (i) with a seed structure containing dual NiFe and NiWRu seed layer 128, (ii) a seed structure containing a single NiWRu seed layer 205, and (iii) a single seed layer of NiFe, respectively. The lines 435, 440, and 445 represent the nucleation field (Hn), which represents the field at which the reversal process begins, for the media with a seed structure containing a single NiWRu seed layer 205, with a seed structure containing dual NiFe and NiWRu seed layer 128, and a single seed layer of NiFe, respectively.

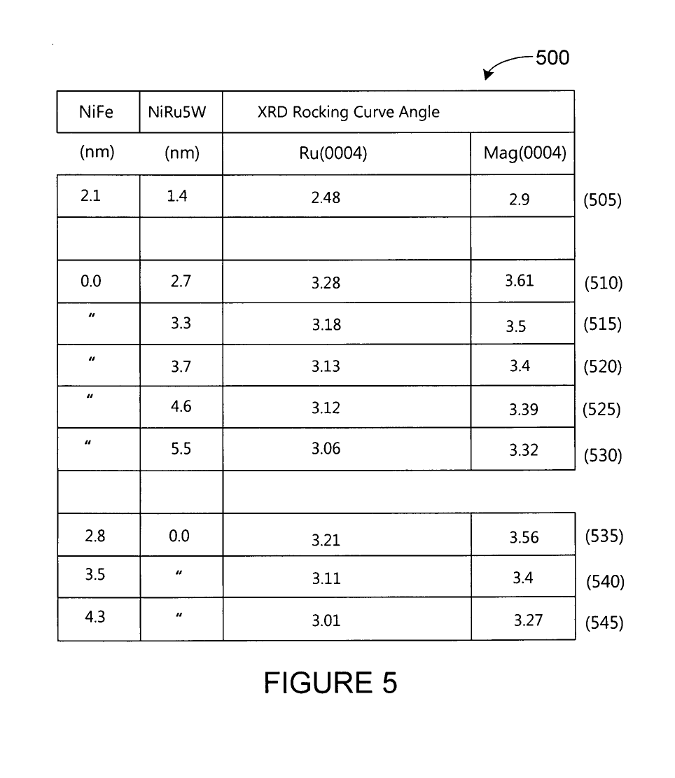

FIG. 5 is a chart 500 showing rocking curve angle values for seed layer structures in accordance with various embodiments of the invention. As shown in row 505, for the dual seed layer structure 128 (FIG. 1) (with NiFe20 seed layer thickness of 2.1 nm and NiRu5W6 seed layer thickness of 1.4 nm), the rocking curve angle in the recording layer 135 is approximately 2.9 degrees. The rows 510-530 show the rocking curve angle values of the single seed layer structure 205 (FIG. 2) (with NiRu5W6 seed layer thickness at various values). The rows 535-545 show the rocking curve angle values of a single NiFe20 seed layer thickness at various values. As shown in the chart 500, the dual seed layer structure 128 at the thinner total size of 3.5 nm achieves an additional 0.5 degrees in decrease of in the Mag (0004) rocking curve angle as compared to the single seed layer structure 205 with the NiRu5W6 seed layer of 3.7 nm as well as a single NiFe20 seed layer of 3.5 nm.

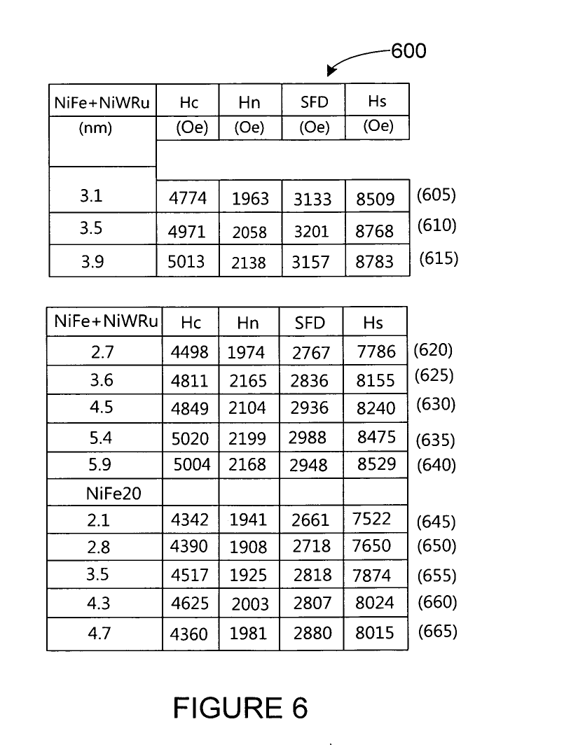

FIG. 6 is a chart 600 showing recording performance for seed layer structures in accordance with various embodiments of the invention. Values for the coercivity field (Hc), nucleation field (Hn), switching field distribution (SFD), and saturation magnetic field (Hs) are listed for media with various thickness values of the dual seed layer structure 128 (NiFe20/NiRu5W6), the single seed layer structure 205 (NiRu5W6), and the seed layer NiFe20. The coercivity of a dual seed layer structure 128 with a thickness of 3.5 nm is higher, as shown in row 610, as compared to the coercivity of a similar thickness single seed layer structure 205, as shown in row 625, and similar thickness single NiFe20 seed layer, as shown in row 655. However, the similar thickness single seed layer structure 205 (with NiRu5W6) has higher coercivity values as compared to a similar thickness NiFe20 seed layer.

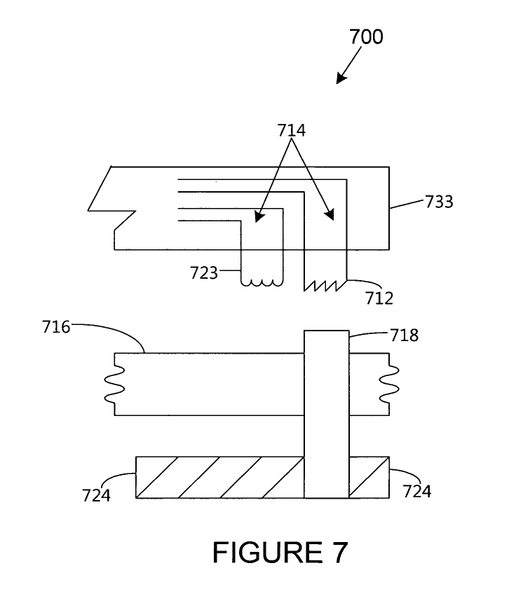

FIG. 7 is a block diagram of a magnetic disk drive 700 that can operate with a magnetic recording media 716 in accordance with an embodiment of the invention. In operation, the slider 733 is supported by a suspension as the slider flies above a disk 716. The slider 733 includes the write head 723 that performs the task of writing magnetic transitions and the read head 712 that performs the task of reading the magnetic transitions. The electrical signals to and from the heads (read head 712 and write head 723) travel along the conductive paths 714 (e.g., leads) which are attached to or embedded in the slider suspension. The slider 733 is positioned over points of varying radial distances from the center of the disk 716 when the slider 733 performs reads or writes on the circular tracks (not shown) on the disk 716.

The disk 716 is attached to a spindle 718 that is driven by a spindle motor 724 for rotating the disk 716. As similarly discussed above, the disk 716 includes a substrate on which a plurality of thin films are deposited. The thin films include ferromagnetic material in which the write head 723 records the magnetic transitions in which information is encoded. The read head 712 reads information encoded by the magnetic transitions in the thin film ferromagnetic material. Other types of disk drive systems can be used with a disk according to an embodiment of the invention.

Other variations and modifications of the above-described embodiments and methods are possible in light of the teaching discussed herein.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. An apparatus comprising:
a perpendicular magnetic recording medium comprising:
a substrate;
a soft under layer above the substrate;
a seed layer structure directly on the soft under layer, wherein the seed layer structure comprises a seed layer that contains Ruthenium;
wherein the seed layer is directly on the soft under layer; and
a magnetic recording layer above the seed layer structure.

2. The apparatus of claim 1, further comprising: an intermediate layer above and directly on the seed layer structure.

3. The apparatus of claim 1, further comprising: an overcoat above the magnetic recording layer.

4. The apparatus of claim 1, wherein the seed layer structure is approximately 10 nm or less in thickness.

5. The apparatus of claim 1 wherein the seed layer structure has a composition of NiW (2-10 at. %) Ru (3-9 at. %).

6. The apparatus of claim 1, wherein the seed layer structure has a composition of NiW (6-8 at. %) Ru (4-6 at. %).

7. The apparatus of claim 1, wherein the seed layer structure comprises NiWRu.

8. The apparatus of claim 7, wherein the concentration of Ru in the seed layer structure comprising Ru is between 3 at. %. and 9 at. %.

9. An apparatus comprising:
a perpendicular magnetic recording medium comprising:
a substrate;
a soft under layer above the substrate;
a seed layer structure directly on the soft under layer, wherein the seed layer structure comprises a first seed layer directly on the magnetic soft under layer and a second seed layer directly on the first seed layer and wherein the second seed layer contains Ruthenium; and
a magnetic recording layer above the seed layer structure.

10. The apparatus of claim 9, wherein the first seed layer comprises NiFe.

11. The apparatus of claim 9, wherein the second seed layer comprises NiWRu.

12. The apparatus of claim 9, further comprising: an intermediate layer above and directly on the seed layer structure.

13. The apparatus of claim 9, further comprising: an overcoat above the magnetic recording layer.

14. The apparatus of claim 9, wherein the seed layer structure is approximately 10 nm or less in thickness.

15. The apparatus of claim 9, wherein the seed layer structure comprises NiWRu.

16. The apparatus of claim 15, wherein the concentration of Ru in the seed layer structure comprising Ru is between 3 at. %. and 9 at. %.

17. An apparatus comprising:
a magnetic disk drive comprising:
a magnetic head for writing magnetic transitions in a perpendicular magnetic recording medium on a disk; and
the disk with the perpendicular magnetic recording medium comprising:
a substrate;
a soft under layer above the substrate;
a seed layer structure directly on the soft under layer, wherein the seed layer structure comprises a seed layer that contains Ruthenium;
wherein the seed layer is directly on the soft under layer; and
a magnetic recording layer above the seed layer structure.

18. An apparatus comprising:
a perpendicular magnetic recording medium comprising:
a substrate;
a soft under layer above the substrate;
a magnetic recording layer; and
means for controlling an orientation of grains in the magnetic recording layer, wherein the controlling means is directly on the soft under layer and wherein the controlling means comprises a seed layer that contains Ruthenium, wherein the seed layer is directly on the soft under layer.

19. A method comprising:
providing a substrate;
forming a soft under layer above the substrate;
forming a seed layer structure above and directly on the soft under layer, wherein the seed layer structure comprises a seed layer that contains Ruthenium;
wherein the seed layer is directly on the soft under layer; and
forming a magnetic recording layer above the seed layer structure, wherein the recording layer is part of a perpendicular magnetic recording medium.

20. The method of claim 19, further comprising: forming an overcoat above the magnetic recording layer.

21. The method of claim 19, wherein the seed layer structure is approximately 10 nm or less in thickness.

22. The method of claim 19 wherein the seed layer structure has a composition of NiW (2-10 at. %) Ru (3-9 at. %).

23. The method of claim 19, wherein the seed layer structure has a composition of NiW (6-8 at. %) Ru (4-6 at. %).

24. The method of claim 19, wherein the seed layer structure comprises NiWRu.

25. A perpendicular magnetic recording medium produced in accordance with the method of claim 19.
